(19) United States
(12) Patent Application Publication
(10) Pub. No.: US 2011/0178811 A1
(43) Pub. Date: Jul. 21, 2011

(54) NAVIGATION SYSTEM WITH GEOFENCE VALIDATION AND METHOD OF OPERATION THEREOF

(75) Inventor: John Sheridan, Broadlands, VA (US)

(73) Assignee: TELENAV, INC., Sunnyvale, CA (US)

(21) Appl. No.: 12/689,894

(22) Filed: Jan. 19, 2010

(51) Int. Cl. G01C 21/00; G06Q 99/00

(52) U.S. Cl. 705/1.1; 701/207; 701/201

(57) ABSTRACT

A method of operation of a navigation system includes: delivering a first message with a target location for a first business for displaying on a device; receiving a current location for locating the device; calculating a business detection geofence encompassing the target location for detecting the location of the device in the target area of the business detection geofence; detecting an entry to the business detection geofence for detecting the current location of the device being at or within the business detection geofence; detecting an encounter between the device and the business detection geofence for the entry into the business detection geofence in a response to the first message; and determining a uniqueness of the encounter for indicating the encounter between the device and the business detection geofence.

### TECHNICAL FIELD

The present invention relates generally to a navigation system, and more particularly to a navigation system for geofence validation of an encounter type.

### BACKGROUND ART

Modern portable consumer and industrial electronics provide increasing levels of functionality to support modern life including location-based information services. This is especially true for client devices such as navigation systems, cellular phones, portable digital assistants, and multifunction devices.

As users adopt mobile location-based service devices, new and old usages begin to take advantage of this new device space. There are many solutions to take advantage of this new device opportunity. One existing approach is to use location information to provide navigation services, such as a global positioning service (GPS) navigation system for a mobile device.

In response to consumer demand, navigation systems are providing ever-increasing amounts of information requiring these systems to improve usability, performance, and accuracy. This information includes transaction information, map data, financial information, local weather, and local driving conditions. The demand for more information and the need to provide user-friendly experience, low latency, and accuracy continue to challenge the providers of navigation systems.

Navigation system and service providers are continually making improvements in order to be competitive. In navigation services, demand for better usability and functionality by providing additional information is increasingly important.

Thus, a need still remains for a navigation system with geofence validation of encounter type mechanism to efficiently manage and measure the utilization and effectiveness of mobile messaging. In view of the growth in mobile messaging, it is increasingly critical that answers be found to these problems. In view of the ever-increasing competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a navigation system including: delivering a first message with a target location for a first business for displaying on a device; receiving a current location for locating the device; calculating a business detection geofence encompassing the target location for detecting the location of the device in the target area of the business detection geofence; detecting an entry into the business detection geofence for detecting the current location of the device being at or within the business detection geofence; detecting an encounter between the device and the business detection geofence for the entry into the business detection geofence in a response to the first message; and determining a uniqueness of the encounter for indicating the encounter between the device and the business detection geofence.

The present invention provides a navigation system including: a control unit for delivering a first message with a target location for a first business for displaying on a device; a location unit, coupled to the control unit, for receiving a current location for monitoring the device; a calculate detection geofence module, coupled to the location unit, for calculating a business detection geofence encompassing the target location of the first business for detecting the device; a navigation module, coupled to the location unit, for detecting an entry to the business detection geofence for detecting the current location at or within the business detection geofence; a detect encounter module, coupled to the control unit, for detecting an encounter in a response to the first message; and a validate encounter type module, coupled to the control unit, for determining a uniqueness of the encounter.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a navigation system with geofence validation of encounter type mechanism in a first embodiment of the present invention.

FIG. 2 is a first example of a display interface of the first device.

FIG. 3 is a second example of the display interface of the first device.

FIG. 4 is a third example of the display interface.

FIG. 5 is a fourth example of the display interface.

FIG. 6 is a fifth example of the display interface.

FIG. 7 is an exemplary block diagram of the first device.

FIG. 8 is an exemplary block diagram of a navigation system with geofence validation of encounter type mechanism in a second embodiment of the present invention.

FIG. 9 is a navigation system with geofence validation of encounter type mechanism in a third embodiment of the present invention.

FIG. 10 is a flow chart of a method of operation of a navigation system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs. Similarly, although the views in the drawings for ease of description generally show similar orientations, this depiction in the FIGs. is arbitrary for the most part. Generally, the invention can be operated in any orientation. The embodiments have been numbered first embodiment, second embodiment, etc. as a matter of descriptive convenience and are not intended to have any other significance or provide limitations for the present invention.

One skilled in the art would appreciate that the format with which navigation information is expressed is not critical to some embodiments of the invention. For example, in some embodiments, navigation information is presented in the format of (X, Y), where X and Y are two ordinates that define the geographic location, i.e., a position of a user.

In an alternative embodiment, navigation information is presented by longitude and latitude related information. In a further embodiment of the present invention, the navigation information also includes a velocity element comprising a speed component and a heading component.

The term “relevant information” referred to herein comprises the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof. For example, the software can be machine code, firmware, embedded code, and application software. Also for example, the hardware can be circuitry, processor, computer, integrated circuit, integrated circuit cores, a pressure sensor, an inertial sensor, a micro-electromechanical system (MEMS), passive devices, or a combination thereof.

The term “navigation routing information” referred to herein is defined as the routing information described as well as information relating to points of interest to the user, such as local business, hours of businesses, types of businesses, advertised specials, traffic information, maps, local events, and nearby community or personal information.

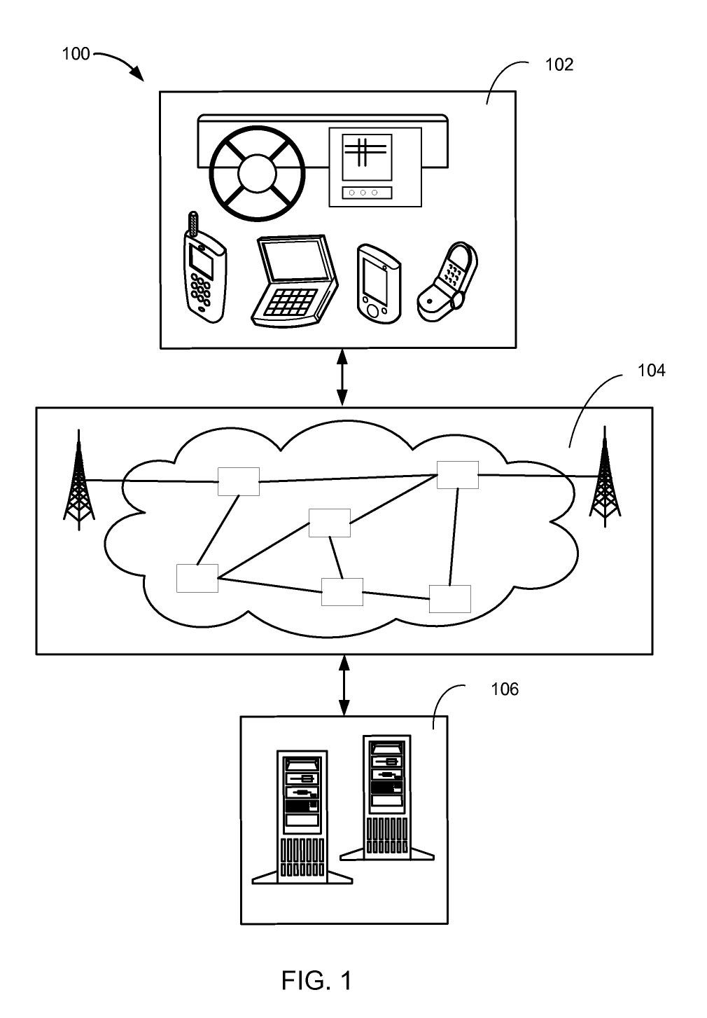

Referring now to FIG. 1, therein is shown a navigation system 100 with geofence validation of encounter type mechanism in a first embodiment of the present invention. The navigation system 100 includes a first device 102, such as a client or a server, connected to a second device 106, such as a client or server, with a communication path 104, such as a wireless or wired network.

For example, the navigation system 100 can include positioning systems that determine location using GPS, cell tower triangulation, cell sector identification, WiFi location, or any combination thereof. That navigation system 100 can be any of a variety of location-based systems that can include automobile routing systems, personal navigation devices, marine navigation systems, aviation navigation systems, mapping systems, data logging systems, or any combination thereof.

In a further example, the first device 102 can be of any of a variety of mobile devices, such as a cellular phone, personal digital assistant, a notebook computer, automotive telematic navigation system, or other multi-functional mobile communication or entertainment device. The first device 102 can be a standalone device, or can be incorporated with a vehicle, for example a car, truck, bus, or train. The first device 102 can couple to the communication path 104 to communicate with the second device 106.

For illustrative purposes, the navigation system 100 is described with the first device 102 as a mobile computing device, although it is understood that the first device 102 can be different types of computing devices. For example, the first device 102 can also be a non-mobile computing device, such as a server, a server farm, or a desktop computer.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102.

In another example, the first device 102 can be a particularized machine, such as a mainframe, a server, a cluster server, rack mounted server, or a blade server, or as more specific examples, an IBM System z10™ Business Class mainframe or a HP ProLiant ML™ server. Yet another example, the second device 106 can be a particularized machine, such as a portable computing device, a thin client, a notebook, a netbook, a smartphone, personal digital assistant, or a cellular phone, and as specific examples, an Apple iPhone™, Palm Centro™, or Moto Q Global™.

For illustrative purposes, the navigation system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, or train.

Also for illustrative purposes, the navigation system 100 is shown with the second device 106 and the first device 102 as end points of the communication path 104, although it is understood that the navigation system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

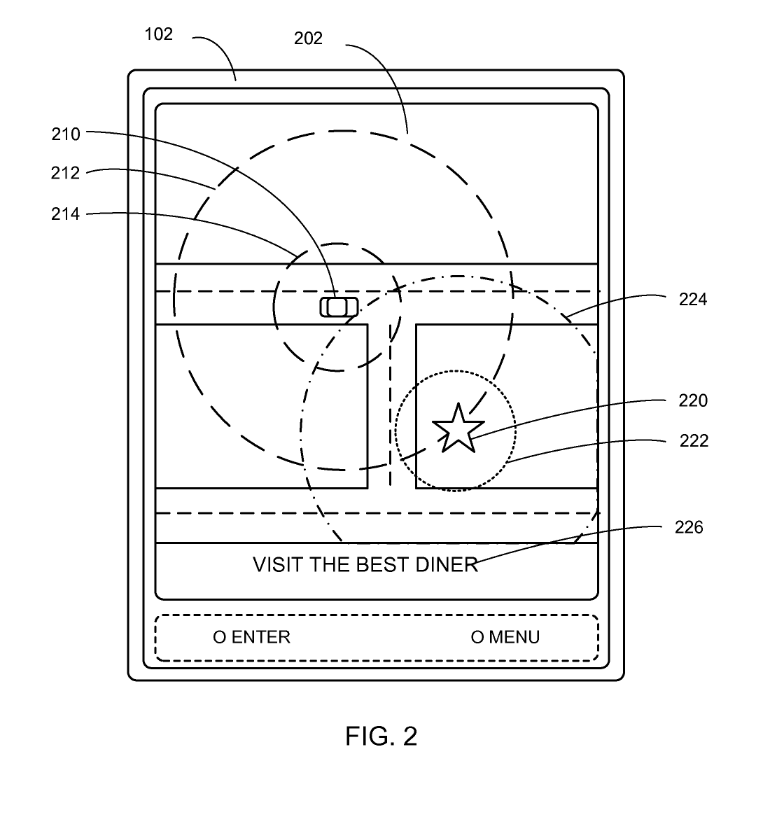

Referring now to FIG. 2, therein is shown a first example of a display interface 202 of the first device 102. The display interface 202 can show a current location 210 of the navigation system 100 of FIG. 1 with a user search geofence 212 and a user detection geofence 214. The display interface 202 can also show a first business 220, a business detection geofence 222, a business message geofence 224, and a first message 226.

The first business 220 can represent an entity that is capable of sending a message or notification to users of the navigation system 100. For example, the first business 220 can represent a company, a restaurant, a national park, a department store, a hair salon, or any combination thereof.

The current location 210 can represent the location of the navigation system 100, which can be represented by geographical coordinates. The current location 210 can include an X-Y coordinate, a latitude and longitude, a polar coordinate, or any combination thereof.

The user search geofence 212 represents a target search area associated with the current location 210 where the user can search for desired businesses. The shape of the user search geofence 212 can be defined by a system default, a user preference, a context-specific shape based on current conditions, or any combination thereof. The user search geofence 212 can be represented by a particular shape including a polygon, circle or other shape.

For example, in a context where the user is driving along a freeway, the shape of the user search geofence 212 can be rectangle with the current location 210 on one end of the rectangle and with the long side aligned in the direction of travel to allow searching for businesses ahead of the current location 210. In another example, in a context where the user is driving on city streets, the shape of the user search geofence 212 can be a circle centered on the current location 210. In still another example, the shape of the user search geofence 212 can be set to be a circular area as defined by the system default setting or in a user setting.

The size of the user search geofence 212 can be defined by a system default, a user preference, the type of search being performed, a context specific size, or any combination thereof. For example, the size of the user search geofence 212 can be determined by the area that can be reached in a predetermined time. The predetermined time is some time set as a system default time or a time set by the user. The predetermined time can represent a threshold of time based on travel speed to search for a business from the current location 210. For example, the predetermined time can be set by the user and be set to a value such as “5 minutes” or “30 minutes”.

In the context where the user is driving along a freeway at sixty miles per hour, the size of the user search geofence 212 can be a rectangle one mile wide and sixty miles long. This can allow the navigation system 100 to use a defined area that is within a one hour travel time of the current location 210. In another example, in a context where the user is searching for a restaurant at lunchtime and driving at thirty miles an hour, the user search geofence 212 can target a circular area with a radius of ten miles to allow the user to find a nearby restaurant in time for lunch.

The user detection geofence 214 represents a detection area or buffer zone around the current location 210 that is monitored to detect when the first business 220 has been reached. The shape and size of the user detection geofence 214 can be defined by a system default, a user preference, a context-specific setting, or a combination thereof. For example, the user detection geofence 214 can be a circular area with a radius of fifty feet. If the navigation system 100 can detect that the location associated with the first business 220 is within fifty feet, then the navigation system 100 has arrived at the first business 220.

The business detection geofence 222 represents a detection area associated with a target location 924 of the first business 220. The business message geofence 224 can represent a defined area associated with the first business 220 where the first message 226 can be broadcast to users in the defined area. The operational settings including the shape, the size, and the position of the business detection geofence 222 and the business message geofence 224 can be determined by using a system default, a user preference, or a context-specific setting based on current conditions. The business detection geofence 222 and the business message geofence 224 are further described in a later section.

The first message 226 can represent a communication from the first business 220 to the user. The first message 226 can include a variety of message types. For example, the first message 226 can include a time-sensitive notice, directions, notifications, alerts, or any combination thereof.

For example, the current location 210 can represent the location of a user that wishes to find a restaurant. The display interface 202 can show the restaurants that lie at or within the user search geofence 212, including the first business 220. The display interface 202 can present the first message 226 of the first business 220 that can represent a notification for the first business 220. In another example, the first message 226 can be delivered to users of the navigation system 100 where the current location 210 is at or within the business message geofence 224.

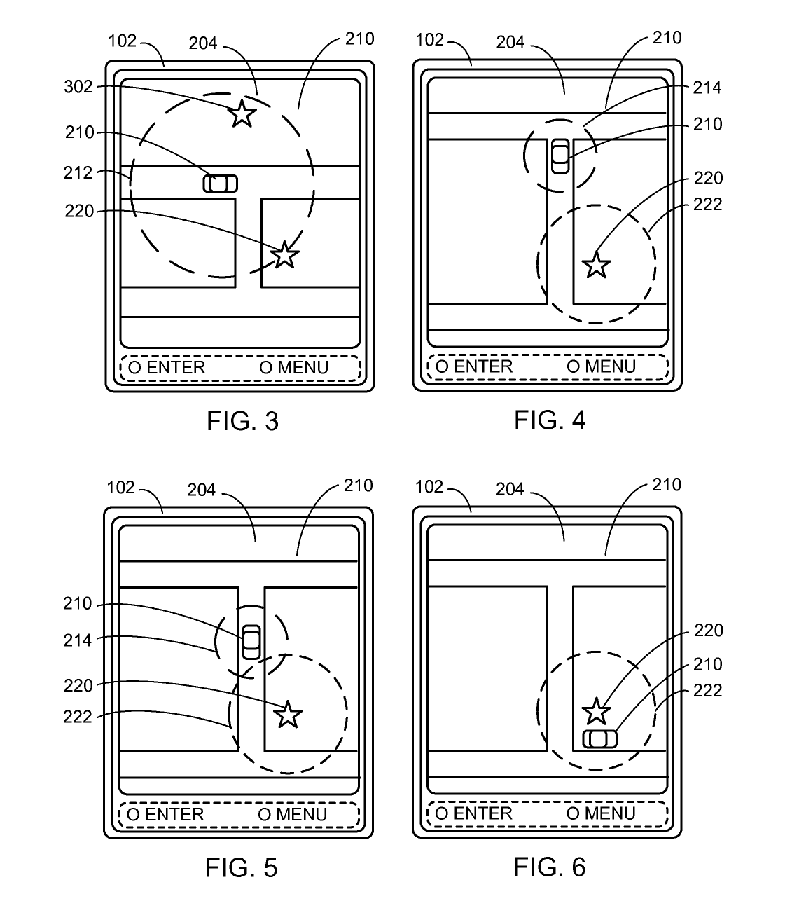

Referring now to FIG. 3, therein is shown a second example of the display interface 202 of the first device 102. The display interface 202 can depict the situation where a user wants to find a restaurant, as an example.

The user can initiate the search for a restaurant by entering a search term such as “diner”. The navigation system 100 of FIG. 1 can search for restaurants by calculating the user search geofence 212 around the current location 210 and identifying restaurants that have locations at or within the user search geofence 212. The user search geofence 212 can define the target area to search for potential restaurants that match the search term “diner”.

For example, if the user is currently navigating along city streets at twenty miles per hour, then the navigation system 100 can calculate the user search geofence 212 in the shape of a circle with a radius of ten miles. The navigation system 100 can display all candidate restaurants that are located at or within the user search geofence 212 on the display interface 202.

The display interface 202 can indicate that the first business 220, the “Best Diner”, and an alternate business 302, the “OK Diner”, are at or within the user search geofence 212. The user can select the first business 220, “Best Diner”, and the display interface 202 can present the first message 226 from the first business 220. The user can then use the navigation system 100 to navigate toward the first business 220, “Best Diner”.

Referring now to FIG. 4, therein is shown a third example of the display interface 202. The display interface 202 can depict the situation where the user is navigating toward the first business 220.

As the user navigates toward the first business 220, the navigation system 100 of FIG. 1 can dynamically calculate the user detection geofence 214 around the current location 210 as it moves toward the first business 220. The user detection geofence 214 can be used to detect when the navigation system 100 is near the targeted location of the first business 220.

The user detection geofence 214 represents a detection area around the user that is monitored to detect when the business detection geofence 222 of the first business 220 has been entered. In this example, the user detection geofence 214 can be defined as a circle ten feet in radius centered on the current location 210.

The navigation system 100 can calculate the business detection geofence 222 associated with the first business 220 to define the destination area that indicates when the first business 220 has been reached. The size and shape of the business detection geofence 222 can be individually defined for the first business 220. Here, the business detection geofence 222 can be defined as a circle with a one hundred foot radius centered on the first business 220.

Referring now to FIG. 5, therein is shown a fourth example of the display interface 202. The display interface 202 can depict the situation where the user is navigating toward the first business 220 and is approaching the business detection geofence 222.

As the user navigates toward the desired location, the navigation system 100 of FIG. 1 can recalculate the user detection geofence 214 each time the current location 210 changes. The navigation system 100 can determine when the user is close to the target destination of the first business 220 by monitoring the area encompassed by the user detection geofence 214 and detecting when the business detection geofence 222 intersects or overlaps with the user detection geofence 214. Being close to the target destination of the first business 220 can represent the situation where the user has responded to the first message 226 from the first business 220, driven to the first business 220, and parked on the street next to the first business 220.

Referring now to FIG. 6, therein is shown a fifth example of the display interface 202. The display interface 202 can depict the situation where the user has navigated toward the first business 220 and has arrived at the first business 220.

The navigation system 100 of FIG. 1 can determine when the user has arrived at the first business 220 by detecting that the current location 210 is within the business detection geofence 222. The navigation system 100 can also determine if the user has stopped moving. This can indicate that the user has arrived at the first business 220 and parked in the parking lot or on an adjacent side street. Once the user has arrived at the first business 220, the navigation system 100 can determine if this is the first time the user has visited the first business 220 or if the user is a repeat customer.

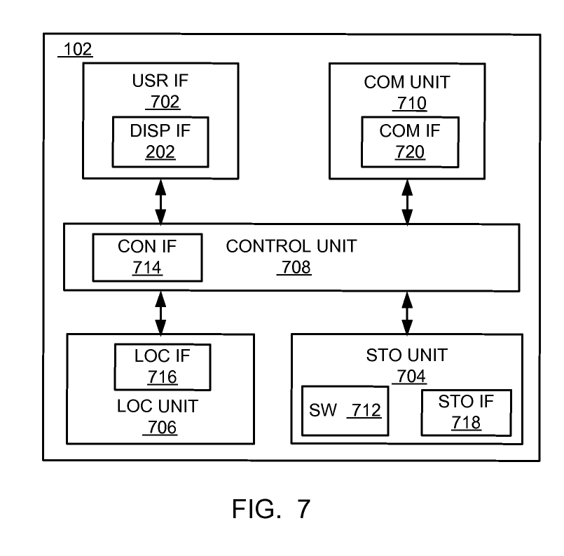

Referring now to FIG. 7, therein is shown an exemplary block diagram of the first device 102. The first device 102 can include a user interface 702, a storage unit 704, a location unit 706, a control unit 708, and a communication unit 710.

The user interface 702 allows a user (not shown) to interface and interact with the first device 102. The user interface 702 can include an input device and an output device. Examples of the input device of the user interface 702 can include a keypad, a touchpad, soft-keys, a keyboard, a microphone, or any combination thereof to provide data and communication inputs. Examples of the output device of the user interface 702 can include the display interface 202. The display interface 202 can include a display, a projector, a video screen, a speaker, or any combination thereof.

The control unit 708 can execute a software 712 to provide the intelligence of the navigation system 100. The control unit 708 can operate the user interface 702 to display information generated by the navigation system 100. The control unit 708 can also execute the software 712 for the other functions of the navigation system 100, including receiving location information from the location unit 706. The control unit 708 can further execute the software 712 for interaction with the communication path 104 of FIG. 1 via the communication unit 710.

The control unit 708 can be implemented in a number of different manners. For example, the control unit 708 can be a processor, an embedded processor, a microprocessor, a hardware control logic, a hardware finite state machine (FSM), a digital signal processor (DSP), or a combination thereof.

The control unit 708 can include a controller interface 714. The controller interface 714 can be used for communication between the control unit 708 and other functional units in the first device 102. The controller interface 714 can also be used for communication that is external to the first device 102.

The controller interface 714 can receive information from the other functional units or from external sources, or can transmit information to the other functional units or to external destinations. The external sources and the external destinations refer to sources and destinations external to the first device 102.

The controller interface 714 can be implemented in different ways and can include different implementations depending on which functional units or external units are being interfaced with the controller interface 714. For example, the controller interface 714 can be implemented with a pressure sensor, an inertial sensor, a micro-electromechanical system (MEMS), optical circuitry, waveguides, wireless circuitry, wireline circuitry, or a combination thereof.

The location unit 706 can generate location information, current heading, and a current speed 942 of the first device 102, as examples. The location unit 706 can be implemented in many ways. For example, the location unit 706 can function as at least a part of a global positioning system (GPS), an inertial navigation system, a cellular-tower location system, a pressure location system, WiFi location, cell sector identification, or any combination thereof.

The location unit 706 can include a location interface 716. The location interface 716 can be used for communication between the location unit 706 and other functional units in the first device 102. The location interface 716 can also be used for communication that is external to the first device 102.

The location interface 716 can receive information from the other functional units or from external sources, or can transmit information to the other functional units or to external destinations. The external sources and the external destinations refer to sources and destinations external to the first device 102.

The location interface 716 can include different implementations depending on which functional units or external units are being interfaced with the location unit 706. The location interface 716 can be implemented with technologies and techniques similar to the implementation of the controller interface 714.

The storage unit 704 can store the software 712. The storage unit 704 can also store the relevant information, such as messages, notifications, points of interest (POI), navigation routing entries, or any combination thereof.

The storage unit 704 can be a volatile memory, a nonvolatile memory, an internal memory, an external memory, or a combination thereof. For example, the storage unit 704 can be a nonvolatile storage such as non-volatile random access memory (NVRAM), Flash memory, disk storage, or a volatile storage such as static random access memory (SRAM).

The storage unit 704 can include a storage interface 718. The storage interface 718 can be used for communication between the location unit 706 and other functional units in the first device 102. The storage interface 718 can also be used for communication that is external to the first device 102.

The storage interface 718 can receive information from the other functional units or from external sources, or can transmit information to the other functional units or to external destinations. The external sources and the external destinations refer to sources and destinations external to the first device 102.

The storage interface 718 can include different implementations depending on which functional units or external units are being interfaced with the storage unit 704. The storage interface 718 can be implemented with technologies and techniques similar to the implementation of the controller interface 714.

The communication unit 710 can enable external communication to and from the first device 102. For example, the communication unit 710 can permit the first device 102 to communicate with the second device 106 of FIG. 1, an attachment, such as a peripheral device or a computer desktop, and the communication path 104.

The communication unit 710 can also function as a communication hub allowing the first device 102 to function as part of the communication path 104 and not limited to be an end point or terminal unit to the communication path 104. The communication unit 710 can include active and passive components, such as microelectronics or an antenna, for interaction with the communication path 104.

The communication unit 710 can include a communication interface 720. The communication interface 720 can be used for communication between the communication unit 710 and other functional units in the first device 102. The communication interface 720 can receive information from the other functional units or can transmit information to the other functional units.

The communication interface 720 can include different implementations depending on which functional units are being interfaced with the communication unit 710. The communication interface 720 can be implemented with technologies and techniques similar to the implementation of the controller interface 714.

For illustrative purposes, the navigation system 100 is shown with the partition having the user interface 702, the storage unit 704, the location unit 706, the control unit 708, and the communication unit 710 although it is understood that the navigation system 100 can have a different partition. For example, the software 712 can be partitioned differently such that some or all of its function can be in the control unit 708, the location unit 706, and the communication unit 710. Also, the first device 102 can include other functional units not shown in FIG. 7 for clarity.

The functional units in the first device 102 can work individually and independently of the other functional units. The first device 102 can work individually and independently from the second device 106 and the communication path 104.

The navigation system 100 can include the control unit 708 coupled to the communication unit 710. The navigation system 100 can include the display interface 202, the storage unit 704, and the controller interface 714 coupled to the control unit 708.

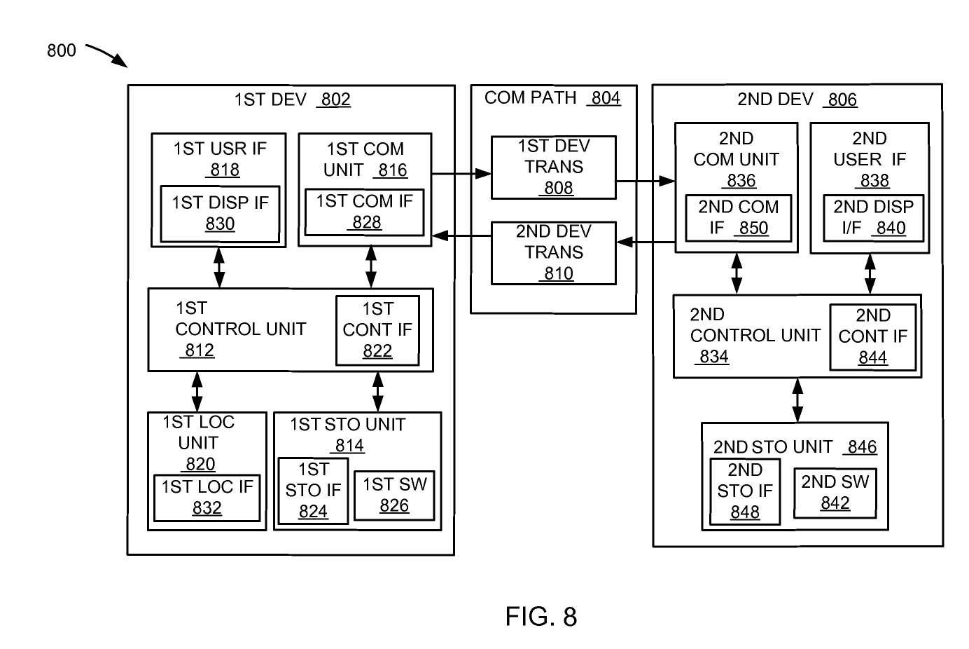

Referring now to FIG. 8, therein is shown an exemplary block diagram of a navigation system 800 with geofence validation of encounter type mechanism in a second embodiment of the present invention. The navigation system 800 can include a first device 802, a communication path 804, and a second device 806.

The first device 802 can communicate with the second device 806 over the communication path 804. For example, the first device 802, the communication path 804, and the second device 806 can be the first device 102 of FIG. 1, the communication path 104 of FIG. 1, and the second device 106 of FIG. 1, respectively. The screen shot shown on the display interface 202 described in FIG. 2 can represent the screen shot for the navigation system 800.

The first device 802 can send information in a first device transmission 808 over the communication path 804 to the second device 806. The second device 806 can send information in a second device transmission 810 over the communication path 804 to the first device 802.

For illustrative purposes, the navigation system 800 is shown with the first device 802 as a client device, although it is understood that the navigation system 800 can have the first device 802 as a different type of device. For example, the first device 802 can be a server.

Also for illustrative purposes, the navigation system 800 is shown with the second device 806 as a server, although it is understood that the navigation system 800 can have the second device 806 as a different type of device. For example, the second device 806 can be a client device.

For brevity of description in this embodiment of the present invention, the first device 802 will be described as a client device and the second device 806 will be described as a server device. The present invention is not limited to this selection for the type of devices. The selection is an example of the present invention.

The first device 802 can include a first control unit 812, a first storage unit 814, a first communication unit 816, a first user interface 818, and a first location unit 820. The first device 802 can be similarly described by the first device 102.

The first control unit 812 can include a first controller interface 822. The first control unit 812 and the first controller interface 822 can be similarly described as the control unit 708 of FIG. 7 and the controller interface 714 of FIG. 7, respectively.

The first storage unit 814 can include a first storage interface 824. The first storage unit 814 and the first storage interface 824 can be similarly described as the storage unit 704 of FIG. 7 and storage interface 718 of FIG. 7, respectively. A first software 826 can be stored in the first storage unit 814.

The first communication unit 816 can include a first communication interface 828. The first communication unit 816 and the first communication interface 828 can be similarly described as the communication unit 710 of FIG. 7 and the communication interface 720 of FIG. 7, respectively.

The first user interface 818 can include a first display interface 830. The first user interface 818 and the first display interface 830 can be similarly described as the user interface 702 of FIG. 7 and the display interface 202 of FIG. 7, respectively.

The first location unit 820 can include a first location interface 832. The first location unit 820 and the first location interface 832 can be similarly described as the location unit 706 of FIG. 7 and the location interface 716 of FIG. 7, respectively.

The performance, architectures, and type of technologies can also differ between the first device 102 and the first device 802. For example, the first device 102 can function as a single device embodiment of the present invention and can have a higher performance than the first device 802. The first device 802 can be similarly optimized for a multiple device embodiment of the present invention.

For example, the first device 102 can have a higher performance with increased processing power in the control unit 708 compared to the first control unit 812. The storage unit 704 can provide higher storage capacity and access time compared to the first storage unit 814.

Also for example, the first device 802 can be optimized to provide increased communication performance in the first communication unit 816 compared to the communication unit 710. The first storage unit 814 can be sized smaller compared to the storage unit 704. The first software 826 can be smaller than the software 712 of FIG. 7.

The second device 806 can be optimized for implementing the present invention in a multiple device embodiment with the first device 802. The second device 806 can provide the additional or higher performance processing power compared to the first device 802. The second device 806 can include a second control unit 834, a second communication unit 836, and a second user interface 838.

The second user interface 838 allows a user (not shown) to interface and interact with the second device 806. The second user interface 838 can include an input device and an output device. Examples of the input device of the second user interface 838 can include a keypad, a touchpad, soft-keys, a keyboard, a microphone, or any combination thereof to provide data and communication inputs. Examples of the output device of the second user interface 838 can include a second display interface 840. The second display interface 840 can include a display, a projector, a video screen, a speaker, or any combination thereof.

The second control unit 834 can execute a second software 842 to provide the intelligence of the second device 106 of the navigation system 800. The second software 842 can operate in conjunction with the first software 826. The second control unit 834 can provide additional performance compared to the first control unit 812 or the control unit 708.

The second control unit 834 can operate the second user interface 838 to display information. The second control unit 834 can also execute the second software 842 for the other functions of the navigation system 800, including operating the second communication unit 836 to communicate with the first device 802 over the communication path 804.

The second control unit 834 can be implemented in a number of different manners. For example, the second control unit 834 can be a processor, an embedded processor, a microprocessor, a hardware control logic, a hardware finite state machine (FSM), a digital signal processor (DSP), or a combination thereof.

The second control unit 834 can include a second controller interface 844. The second controller interface 844 can be used for communication between the second control unit 834 and other functional units in the second device 806. The second controller interface 844 can also be used for communication that is external to the second device 806.

The second controller interface 844 can receive information from the other functional units or from external sources, or can transmit information to the other functional units or to external destinations. The external sources and the external destinations refer to sources and destinations external to the second device 806.

The second controller interface 844 can be implemented in different ways and can include different implementations depending on which functional units or external units are being interfaced with the second controller interface 844. For example, the second controller interface 844 can be implemented with a pressure sensor, an inertial sensor, a micro-electromechanical system (MEMS), optical circuitry, waveguides, wireless circuitry, wireline circuitry, or a combination thereof.

A second storage unit 846 can store the second software 842. The second storage unit 846 can also store the relevant information, such as notifications, points of interest (POI), navigation routing entries, or any combination thereof. The second storage unit 846 can be sized to provide the additional storage capacity to supplement the first storage unit 814.

For illustrative purposes, the second storage unit 846 is shown as a single element, although it is understood that the second storage unit 846 can be a distribution of storage elements. Also for illustrative purposes, the navigation system 800 is shown with the second storage unit 846 as a single hierarchy storage system, although it is understood that the navigation system 800 can have the second storage unit 846 in a different configuration. For example, the second storage unit 846 can be formed with different storage technologies forming a memory hierarchal system including different levels of caching, main memory, rotating media, or off-line storage.

The second storage unit 846 can be a volatile memory, a nonvolatile memory, an internal memory, an external memory, or a combination thereof. For example, the second storage unit 846 can be a nonvolatile storage such as non-volatile random access memory (NVRAM), Flash memory, disk storage, or a volatile storage such as static random access memory (SRAM).

The second storage unit 846 can include a second storage interface 848. The second storage interface 848 can be used for communication between the location unit 706 and other functional units in the second device 806. The second storage interface 848 can also be used for communication that is external to the second device 806.

The second storage interface 848 can receive information from the other functional units or from external sources, or can transmit information to the other functional units or to external destinations. The external sources and the external destinations refer to sources and destinations external to the second device 806.

The second storage interface 848 can include different implementations depending on which functional units or external units are being interfaced with the second storage unit 846. The second storage interface 848 can be implemented with technologies and techniques similar to the implementation of the second controller interface 844.

The second communication unit 836 can enable external communication to and from the second device 806. For example, the second communication unit 836 can permit the second device 806 to communicate with the first device 802 over the communication path 804.

The second communication unit 836 can also function as a communication hub allowing the second device 806 to function as part of the communication path 804 and not limited to be an end point or terminal unit to the communication path 804. The second communication unit 836 can include active and passive components, such as microelectronics or an antenna, for interaction with the communication path 804.

The second communication unit 836 can include a second communication interface 850. The second communication interface 850 can be used for communication between the second communication unit 836 and other functional units in the second device 806. The second communication interface 850 can receive information from the other functional units or can transmit information to the other functional units.

The second communication interface 850 can include different implementations depending on which functional units are being interfaced with the second communication unit 836. The second communication interface 850 can be implemented with technologies and techniques similar to the implementation of the second controller interface 844.

The first communication unit 816 can couple with the communication path 804 to send information to the second device 806 in the first device transmission 808. The second device 806 can receive information in the second communication unit 836 from the first device transmission 808 of the communication path 804.

The second communication unit 836 can couple with the communication path 804 to send information to the first device 802 in the second device transmission 810. The first device 802 can receive information in the first communication unit 816 from the second device transmission 810 of the communication path 804. The navigation system 800 can be executed by the first control unit 812, the second control unit 834, or a combination thereof.

For illustrative purposes, the second device 106 is shown with the partition having the second user interface 838, the second storage unit 846, the second control unit 834, and the second communication unit 836, although it is understood that the second device 106 can have a different partition. For example, the second software 842 can be partitioned differently such that some or all of its function can be in the second control unit 834 and the second communication unit 836. Also, the second device 806 can include other functional units not shown in FIG. 8 for clarity.

The functional units in the first device 802 can work individually and independently of the other functional units. The first device 802 can work individually and independently from the second device 806 and the communication path 804.

The functional units in the second device 806 can work individually and independently of the other functional units. The second device 806 can work individually and independently from the first device 802 and the communication path 804.

For illustrative purposes, the navigation system 800 is described by operation of the first device 802 and the second device 806. It is understood that the first device 802 and the second device 806 can operate any of the modules and functions of the navigation system 800. For example, the first device 802 is described to operate the first location unit 820, although it is understood that the second device 806 can also operate the first location unit 820.

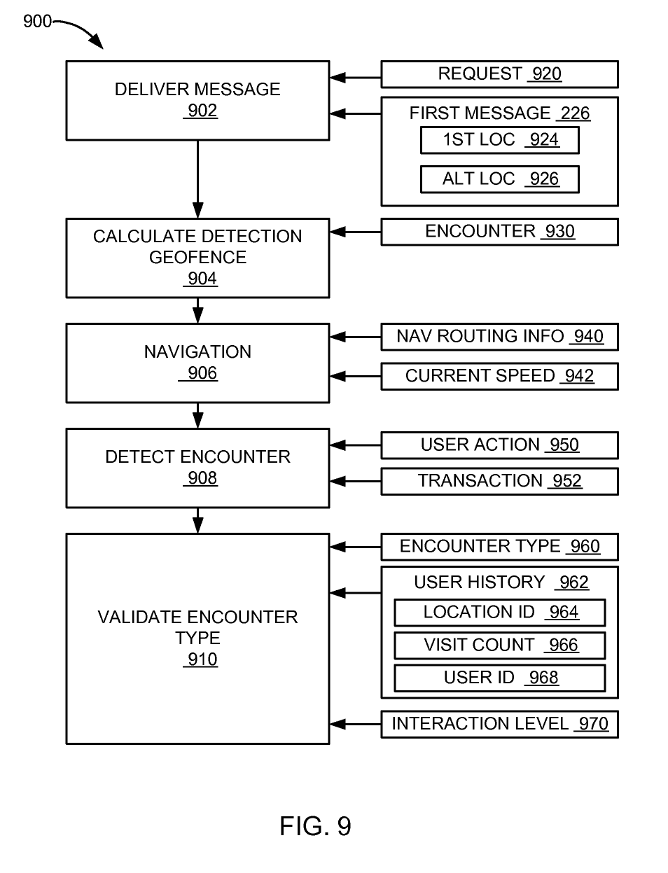

Referring now to FIG. 9, therein is shown a navigation system 900 with geofence validation of encounter type mechanism in a third embodiment of the present invention. The navigation system 900 can enable the navigation to the first business 220 and operate the display interface 202 of FIG. 2 by presenting a navigation routing information 940 of the first business 220.

In the navigation system 900, as an example, each module is indicated by a number and successively higher module numbers follow one another. Control flow can pass from one module to the next higher numbered module unless explicitly otherwise indicated.

The navigation system 900 can be operated in several different ways. For example, the navigation system 900 can be included in and operated by running the software 712 of FIG. 7. In another example, the navigation system 900 can be partitioned between and operated by running the first software 826 of FIG. 8, the second software 842 of FIG. 8, or a combination thereof.

The navigation system 900 can deliver the first message 226 with the target location 924 in a deliver message module 902. The deliver message module 902 can deliver the first message 226 of the first business 220 of FIG. 2 in response to a request 920 from the user. After the first message 226 has been successfully delivered, the control flow can be transferred to a calculate detection geofence module 904.

The deliver message module 902 can deliver the first message 226 with the target location 924 of the first business 220 by receiving the first message 226 and displaying it on the display interface 202 of FIG. 2. The first message 226 can be delivered where the current location 210 is at or within either the user search geofence 212 or the business message geofence 224. The navigation system 900 can receive the current location 210 for locating the device 102.

The first message 226 can include the target location 924 for the first business 220. The target location 924 can indicate the geographical coordinates where the first business 220 wants to deliver the first message 226. The target location 924 can include the location of the first business 220 itself or a different location where the first business 220 wants to send the first message 226. The target location 924 can include the location of the first business 220, a competitor business location, the location of a high user traffic area, or any combination thereof. The target location 924 can include an X-Y coordinate, a longitude and latitude, multiple coordinates, offset distance from a known location, or any combination thereof. The target location 924 can indicate the location of the business message geofence 224.

The first message 226 can be delivered using a variety of methods. For example, the navigation system 900 can deliver the first message 226 for the first business 220 with the target location 924 of the first business 220 that is at or within the user search geofence 212. This can represent the situation where the user is searching for a restaurant in a given area.

The deliver message module 902 can calculate the target search area and the detection area for the navigation system 900. The navigation system 900 can calculate the user search geofence 212 to search the target search area associated with the current location 210 to identify the first business 220. The navigation system 900 can deliver the first message 226 of the first business 220 where the target location 924 is at or within the user search geofence 212.

The target search area is defined by the operational settings including the shape, the size and the position. The operational settings can be determined based on context-specific conditions including the type of search, the physical conditions of the target area, the current route, the current speed 942, or any combination thereof. The type of search can indicate how large the target search area should be to locate a business that matches the search term.

For example, the shape of the target search area can be determined based on the current speed 942, the current route, the current location 210, and the type of search to compensate for the area that can be reached in a predetermined time. If the current location 210 along the current route indicates that the user is on a freeway travelling at a freeway speeds, then the shape of the search target area can be a rectangle with the longer axis aligned with the direction of travel along the freeway. This can allow the search target area to focus on the area along and adjacent to the freeway. If the current location 210 indicates that the user is in the city and travelling at lower city speeds, then the shape of the search target area can be a circle or square. The shape of the search target area can also be defined by the user in a variety of methods including using pre-defined shapes for all searches, user entered shapes, or any combination thereof.

The position of the target search area describes the orientation of the target search area around the current location 210 of the navigation system 900. The position of the search target area can be based on the current speed 942. If the current speed 942 is low, then the position of the search target area is centered on the current location 210. If the current speed 942 is high, then the position of the search target area is offset ahead of the current location 210 to help search for search restaurants ahead of the current location in the direction of travel.

For example, if the current speed 942 is one hundred miles per hour, then the search target area would be positioned such that the current location 210 is closer to the back of the search target area, as seen from the direction of travel. In another example of the positioning of the user search geofence 212, if the navigation system 900 is at rest, then the search target area can be centered on the current location 210.

The size of the target search area and the user search geofence 212 can be varied based on the current speed 942, the current location 210, and the type of search being performed to compensate for the area that can be reached in a predetermined time. The type of search can include a search for an unusual business, a common business, or any combination thereof. The type of search can compensate for the likelihood of finding the search term target within the user search geofence 212.

In an example of determining the size of the search target area, the search for a generic restaurant can accomplished with the search target area limited to a small area to be within a short driving distance to allow for a quick meal. In another size example, the search for a specific type of restaurant, such as an exotic restaurant, can require the target search area to be larger to increase the chances of finding the specific restaurant type. In yet another size example, the size can be determined by the current speed 942, where the size of the user search geofence 212 can be larger when the current speed 942 is higher.

The user search geofence 212 can be calculated to encompass the first device 102 by determining the operational settings of the target search area as defined above and using the operational settings to determine the set of points that define the boundaries of the target search area. The geographical coordinate of each point can be identified by computing the offset from the current location 210 to each point on the edge of the selected shape defined by the operational settings. The user search geofence 212 can also be calculated by determining the set of line segment vectors that define the boundaries indicated by the operational settings. The user search geofence 212 can be calculated for a context-specific area that can be reached within a predetermined time and can encompass the first device 102.

For example, if the user is navigating along city streets, then the operational settings of the user search geofence 212 can indicate that the search target area is a four mile by four mile square centered on the target location 924, and then the user search geofence 212 is calculated by determining the geographical coordinates of the perimeter of the square. In another example, the user search geofence 212 can be calculated by determining the set of four vectors connecting the four vertices of the four mile by four mile square.

The user can enter the request 920 for the search and the navigation system 900 can respond to the request 920 with a list of potential destinations with messages. The navigation system 900 can deliver messages from each restaurant at or within the user search geofence 212. The user can select the first message 226 and begin to navigate toward the target location 924.

In another example of delivering the first message 226, the navigation system 900 can deliver the first message 226 where the current location 210 is at or within the business message geofence 224. The navigation system 900 can calculate the business message geofence 224 around the first business 220 based on the target location 924. This can represent the situation where the first business 220 wants to broadcast the first message 226 to users in a broadcast target area.

The business message geofence 224 represents the broadcast target area associated with the first business 220 and the first message 226 where the first business 220 wants to broadcast the first message 226 to users. The broadcast target area is defined by the operational settings including the shape, the size and the position. The operational settings of the broadcast target area are associated with the first message 226 and can be entered when the first message 226 is created.

The business message geofence 224 can be calculated based on the target location 924 in the first message 226. For example, in the situation where the first business 220 wants to modify and broadcast the first message 226 with a lunch-time offer to nearby users, the broadcast target area can be defined as a circular area with a radius of ten miles centered on the target location 924. This can represent the area within a reasonable lunchtime driving distance of the first business 220.

The first message 226 can be modified based on the distance between the current location 210 and the target location 924 to increase the desirability of the first message 226. The first message 226 can be modified by including additional information emphasizing the distance to the target location 924, the ease of navigation to the target location 924, the opportunity for quick access to the target location 924, or any combination thereof.

The desirability indicates the value of the first message 226 to the user. The higher the desirability, the more valuable the first message 226 is to the user. For example, when it is lunch time and the user is hungry, then if the first message 226 includes an offer for a free meal, it will have a high desirability.

In another example, the first message 226 can specifically target the alternate business 302. The first message 226 can include a special offer intended to entice patrons of the alternate business 302 to visit the first business 220 instead. The broadcast target area can be defined to be a circle with a radius of four miles, centered on an alternate location 926 of the alternate business 302. This can enable the first message 226 to be delivered to users who are within four miles of the alternate business 302 to give those users an alternative choice.

The business message geofence 224 can be calculated by determining the operational settings of the broadcast target area associated with the first message 226 and using the operational settings to determine the set of points that define the boundaries of the broadcast target area. The geographical coordinates of each point can be identified by computing the offset from the target location 924 of the first business 220 to the perimeter of the selected shape. The business message geofence 224 can also be calculated by determining the set of vectors that define the boundaries indicated by the operational settings.

The calculate detection geofence module 904 can calculate the business detection geofence 222 and the user detection geofence 214. The business detection geofence 222 can represent the monitored area associated with the target location 924 of the first business 220 that is used to detect an encounter 930 when the current location 210 is at or within the business detection geofence 222. The user detection geofence 214 can represent the monitored area associated with the current location 210 that is used to detect the encounter 930 when the user detection geofence 214 intersects with the business detection geofence 222. After the business detection geofence 222 of the first business 220 has been calculated, the control flow can be transferred to a navigation module 906.

The business detection geofence 222 can represent the business detection area associated with the first business 220 that can be monitored to detect the presence of the user detection geofence 214 indicating that the encounter 930 has occurred. The business detection area is defined by the operational settings including the shape, the size, and the position. The operational settings of the business detection area can be associated with the first message 226 and can be entered when the first message 226 is created.

The business detection geofence 222 can include areas such as a parking lot associated with the first business 220, a circular area around the target location 924 of the first business 220, nearby streets surrounding the first business 220, the drive-through lane of the first business 220, or any combination thereof. For example, if the business detection geofence 222 is defined as the parking lot of the first business 220, then the navigation system 900 can detect the encounter 930 when the user has driven into the parking lot of the first business 220.

In another example, the business detection geofence 222 can include the drive-through lane of the first business 220 where the first message 226 pertains to the use of the drive-through lane. The navigation system 900 can determine the effectiveness of the first message 226 by detecting if the current location 210 is at or within the business detection geofence 222, indicating that the user responded to the first message 226 and entered the drive-through lane of the first business 220.

The business detection geofence 222 can be calculated by determining the geographical coordinate and boundaries of a polygon or other shape that encompasses the target location 924. The geographical coordinates of the business detection geofence 222 can be calculated by determining the offset between the target location 924 and the boundaries of the polygon. The navigation system 900 can determine whether the current location 210 is at, within, or outside of the business detection geofence 222 by comparing the current location 210 with the area encompassed by the business detection geofence 222.

The business detection geofence 222 can be calculated by determining operational settings of the business detection area associated with the first message 226 and using the operating settings to determine the set of points that define the boundaries of the business detection area. The geographical coordinate of each point can be identified by computing the offset from the target location 924 to the point on the perimeter of the selected shape defined by the operational settings. The user search geofence 212 can also be calculated by determining the set of line segment vectors that define the boundaries indicated by the operational settings.

The business detection geofence 222 can be calculated in a variety of methods. For example, the business detection geofence 222 can be calculated to encompass an area near the first business 220. The business detection geofence 222 can include a circle of given radius centered on the first business 220, a rectangle centered on the first business 220, a polygon shape that defines the parking areas of the first business 220, a polygon shape that defines the building of the first business 220, or any combination thereof.

The user detection geofence 214 represents an area of interest based on the current location 210 that can be monitored to detect the encounter 930. The user detection geofence 214 is defined by the operational settings including the shape, the size and the position. The user detection geofence 214 can includes areas such as a circular area with a radius of 50 feet centered on the current location 210, a square 10 feet on a side centered on the current location 210, or any combination thereof.

The user detection geofence 214 can be calculated by determining the geographical coordinates and boundaries of the polygon or other shape that encompasses the current location 210. The geographical coordinates of the user detection geofence 214 can be calculated by determining the offset between the current location 210 and the boundaries of the polygon.

The user detection geofence 214 can be dynamically calculated as the current location 210 changes. The calculation is dynamic because the calculations to determine the geographical coordinates of the user detection geofence 214 are repeated each time a change in the current location 210 is detected.

The encounter 930 can represent the situation where the current location 210 of the user is at or within the business message geofence 224 of the first business 220. The encounter 930 shows that the user has successfully navigated to the target location 924 of the first business 220.

The navigation module 906 can present the navigation routing information 940 to help the user navigate to the target location 924 of the first business 220 in response to the first message 226. The navigation system 900 can display the navigation routing information 940 to enable the user to physically navigate to the target location 924. After the user has used the navigation system 900 to navigate to the target location 924, the control flow can be transferred to a detect encounter module 908.

The navigation system 900 can navigate to the target location 924 using the navigation routing information 940 to maneuver the user to arrive at the target location 924. Navigating to the target location 924 can include operating the controls of the vehicle or maneuvering according to the navigation routing information 940. The navigation system 900 can detect the entry to business detection geofence 222 of the first business 220, indicating that the encounter 930 has occurred in response to the first message 226, by detecting that the current location 210 is at or within the business detection geofence 222.

The navigation routing information 940 can include visual and audio directions to help the user to operate the vehicle to reach the target location 924. This can include turn-by-turn instructions, mapping information, audio navigation commands, mapping information, or any combination thereof.

The user can use the navigation system 900 to navigate to the target location 924 in a variety of methods. For example, the navigation system 900 can display the route from the current location 210 to the target location 924 on the display interface 202. As the current location 210 changes, the display interface 202 can display the navigation routing information 940 for the updated location. The user can operate the vehicle by making turns as indicated by the navigation routing information 940.

The navigation system 900 can detect the encounter 930 in the detect encounter module 908. The encounter 930 can indicate that the user has successfully navigated to the target location 924. After the encounter 930 has been detected, the control flow can be transferred to a validate encounter type module 910. The navigation system 900 can validate an encounter type 960 in the validate encounter type module 910.

The encounter 930 can be detected by determining when the current location 210 is close enough to the target location 924 to satisfy the criteria of the encounter 930. The encounter 930 can represent an interaction between the user and the first business 220. The encounter 930 between the first device 102 and the business detection geofence 222 can be detected for the entry into the business detection geofence 222 in a response to the first message 226.

The encounter 930 can be detected in a variety of methods. For example, the navigation system 900 can detect the encounter 930 when the user detection geofence 214 intersects with the business detection geofence 222. The intersection can include when a point on the perimeter of the user detection geofence 214 is at or within the business detection geofence 222. The intersection can be detected by comparing the points along the perimeter of the user detection geofence 214 with the area enclosed by the business detection geofence 222. The intersection can also be detected by comparing the points along the perimeter of the user detection geofence 214 with the points along the perimeter of the business detection geofence 222 and determining if any point exists on both perimeters. This situation can indicate that the user is near the first business 220, but has not entered the business detection geofence 222.

In another example of detecting the encounter 930, the navigation system 900 can detect the encounter 930 when the current location 210 is at or within the business detection geofence 222 of the first business 220. This situation can indicate that the user has entered the business detection geofence 222 and has successfully navigated to the target location 924 of the first business 220. The encounter can be detected by comparing the current location 210 with the area enclosed by the business detection geofence 222 or with the points along the perimeter of the business detection geofence 222.

In yet another example of detecting the encounter 930, the navigation system 900 can detect the encounter 930 with the first business 220 as the response to the first message 226 based on detecting the current location 210 as stationary in the business detection geofence 222. This can represent the situation where the current location 210 is at or within the business detection geofence 222 and the current speed 942 of the user is detected to be zero. The navigation system 900 can detect when the current speed 942 is zero if no difference between two successive measurements of the current location 210. This situation can indicate that the user has entered and is stationary in the business detection geofence 222.

In still another example of detecting the encounter 930, the navigation system 900 can detect the encounter 930 when a user action 950 has been detected and the current location 210 is at or within the business detection geofence 222, indicating an interaction with the first business 220 has occurred. The user action 950 can be detected by receiving information about the user action 950 from a web service, a database, an external data storage unit, or any combination thereof. The information about the user action 950 can be received in a variety of methods including direct feeds from external web information systems, express data entry, web data extraction, or a combination thereof. The encounter 930 can also be detected when there is a time delay between the detection of the current location 210 being at or within the business detection geofence 222 and the occurrence of the user action 950.

The user action 950 can represent a transaction 952 that has taken place at the target location 924 of the first business 220 that can be linked to the user. The transaction 952 can include a purchase of an item, a return of an item, a registration, the sale of an item, the exchange of an item, a customer service inquiry, or any combination thereof. The transaction 952 can include the purchase of an item can include the purchase of an item using a cash, a credit card, a debit card, an electronic payment, a store credit, barter, or any combination thereof. The occurrence of the transaction 952 can indicate that the user has engaged with the first business 220.

It has been discovered that the present invention provides the navigation system 900 with geofence validation of encounter type mechanism for improving the accuracy of detecting when the encounter 930 has taken place. The navigation system 900 or the detect encounter module 908 can increase the accuracy of detecting the encounter 930 using the business detection geofence and the user detection geofence 214. This allows the detection of a wider variety of encounters including encounters where the navigation system 900 is near the target location 924 and where the navigation system 900 has come to a complete stop while at or within the business detection geofence 222.

The navigation system 900 can validate the encounter type 960 in the validate encounter type module 910. The validate encounter type module 910 can determine the uniqueness of the encounter 930 for indicating the encounter 930 between the first device 102 and the business detection geofence 222 by validating the encounter type 960 by comparing the encounter 930 to a user history 962.

The uniqueness of the encounter 930 can indicate whether the user has visited the target location 924 before. If the user history 962 indicates that the user has not visited the target location 924 before, then the encounter 930 is unique.

The encounter type 960 can be used to determine an interaction level 970 of the encounter 930. The encounter type 960 can be validated by comparing the encounter 930 with the user history 962 to determine if the user has visited the first business 220 previously.

The encounter type 960 can include several categories. For example, the encounter type 960 can indicate an initial visit if the user history 962 shows that the user has not previously visited the first business 220. In another example, the encounter type 960 can indicate a repeat visit if the user history 962 show that the user has previously visited the target location 924 of the first business 220.

The user history 962 can consist of information regarding previous user visits to the first business 220. The user history 962 can include information such as a location identification 964, a visit count 966, a user identification 968, a business name, a business identification code, a business location, a visit date, a visit time, or any combination thereof.

The user history 962 can be retrieved for the first business 220 by reading a memory such as a local storage, a remote storage, a database, a cache memory, or any combination thereof. The user history 962 can also be retrieved by reading information from a web service, a remote procedure call, a subroutine call, a method, or any combination thereof. The user history can be retrieved using information including the user identification 968, the target location 924, and the first business 220.

The navigation system 900 can determine the interaction level 970 based on delivering the first message 226 and navigating to the target location 924 for the encounter 930 based on the encounter type 960. The interaction level 970 can include a variety of metrics that describe the performance of the navigation system 900 including a per impression metric, a per click metric, a per delivery metric, a per acquisition metric, a per loyalty metric, or any combination thereof.

The interaction level 970 can determine the metric of the number of times the first message 226 has been displayed to the user. The metric per impression represents the initial delivery of the first message 226 to the user. The interaction level 970 can also determine the metric to indicate the number of times the user has selected the first message 226. The metric per click represents the situation where the user had selected the first message 226 by clicking on it.

The interaction level 970 can indicate the metric of the number of times the user has selected the first message 226 and then arrived at the target location 924. The metric per delivery represents the user navigating to the target location 924 of the first message 226 indicating that the user has been delivered to the first business 220.

The interaction level 970 can indicate the metric of the number of times the user has selected the first message 226 and arrived at the target location 924 as a first time visitor. The metric per acquisition of a new customer can represent where the user has navigated to the target location 924 of the first message 226 for the first time based on the user history 962.

The interaction level 970 can indicate the metric of the number of times the user has selected the first message 226 and arrived at the target location 924 as a repeat visitor. The metric per loyalty represents the situation where the user has navigated to the target location 924 of the first message 226 more than one time based on the user history 962. This repeat visit indicates that the user has established a loyalty relationship with the first business 220.

Depending on the encounter type 960 and the metric involved, the navigation system 900 can determine the effectiveness of the first message 226. The navigation system 900 can deliver the first message 226 to the user, detect the encounter 930, validate the encounter type 960 and then determine the effectiveness the first message 226.

The navigation system 900 can be implemented with the navigation system 100 of FIG. 1. Each module of the navigation system 900 can be implemented using a combination of functional modules of the first device 102 of FIG. 7. For example, the navigation system 900 can be implemented by running the software 712 of FIG. 7 on the control unit 708 of FIG. 7.

The deliver message module 902 can be implemented with the first device 102 of FIG. 1. The deliver message module 902 can be implemented with the user interface 702 of FIG. 7, the display interface 202 of FIG. 2, the control unit 708 of FIG. 7, the controller interface 714 of FIG. 7, the software 712 of FIG. 7, the storage unit 704 of FIG. 7, the storage interface 718 of FIG. 7, the location unit 706 of FIG. 7, the location interface 716 of FIG. 7, the communication unit 710 of FIG. 7, the communication interface 720 of FIG. 7 or a combination thereof.

For example, the deliver message module 902 can deliver the first message 226 with the target location 924 where the target location 924 is at or within the user search geofence 212 using the communication unit 710, the control unit 708, and the location unit 706. The first message 226 can be displayed on the user interface 702. The user can select the first message 226 that is displayed on the user interface 702 and store it in the storage unit 704 using the storage interface 718.

In another example, the control unit 708 can receive the current location 210 from the location unit 706. The control unit 708 can also calculate the user search geofence 212 for a context-specific area that can be reached within a predetermined time. The user search geofence 212 can use the control unit 708 and the controller interface 714 to vary the size of the user search geofence 212 based on the type of search being performed.

In yet another example, the deliver message module 902 can deliver the first message 226 based on the current location 924 being at or within the business message geofence 224 using the control unit 708 and the storage unit 704 to calculate the business message geofence 224 encompassing the target location 924. The deliver message module 902 can use the location unit 706 for modifying the first message 226 based on the distance between the current location 210 and the target location 924 for increasing the desirability of the first message 226.

The calculate detection geofence module 904 can be implemented with the first device 102. The calculate detection geofence module 904 can be implemented with the control unit 708, the controller interface 714, the software 712, the storage unit 704, the storage interface 718, the location unit 706, the location interface 716 or a combination thereof. For example, the control unit 708 can calculate the business detection geofence 222 of the first business 220 using the target location 924 that is stored in the storage unit 704 and the location unit 706.

In another example, the calculate detection geofence module 904 can use the control unit 708 and the location unit 706 to calculate the user detection geofence 214 based on the current location 210.

The navigation module 906 can be implemented with the first device 102. The navigation module 906 can be implemented with the control unit 708, the controller interface 714, the software 712, the location unit 706, the location interface 716, the display interface 202, the user interface 702, or a combination thereof.

For example, the navigation system 900 can navigate the user to the target location 924 using the control unit 708 to send the navigation routing information 940 to the user interface 702 for displaying on the display interface 202. The location unit 706 can determine the current location 210 to be used to update the display interface 202. The navigation module 906 can detect the entry to the business detection geofence 222 using the location unit 706 to receive the current location 210.

The detect encounter module 908 can be implemented with the first device 102. The detect encounter module 908 can be implemented with the control unit 708, the controller interface 714, the software 712, the storage unit 704, the storage interface 718, the location unit 706, the location interface 716, the communication unit 710, the communication interface 720, the display interface 202, the user interface 702, or a combination thereof.

For example, the navigation system 900 can detect the encounter 930 using the control unit 708 and the location unit 706 to determine where the current location 210 is at or within the business detection geofence 222. The detect encounter module 908 can use the control unit 708 to retrieve the current location 210 from the location unit 706.

The detect encounter module 908 can use the control unit 708 for detecting when the user detection geofence 214 intersects the business detection geofence 222. In another example, the detect encounter module 908 can use the location unit 706 for detecting the encounter 930 with the first business 220 as the response to the first message 226 based on detecting the current location 210 as stationary in the business detection geofence 222.

The validate encounter type module 910 can be implemented with the first device 102. The validate encounter type module 910 can be implemented with the control unit 708, the controller interface 714, the software 712, the location unit 706, the location interface 716, the storage unit 704, the storage interface 718, the communication unit 710, the communication interface 720, the display interface 202, the user interface 702, or a combination thereof.

For example, the navigation system 900 can validate the encounter type 960 of the encounter 930 using the control unit 708 and the communication unit 710 to determine the uniqueness of the encounter 930.

The navigation system 900 can be partitioned between the first device 802 of FIG. 8 and the second device 806 of FIG. 8. For example, the navigation system 900 can be partitioned into the functional units of the first device 802, the second device 806, or a combination thereof. The navigation system 900 can also be implemented as additional functional units in the first device 102 of FIG. 1, the first device 802, the second device 806, or a combination thereof.

The deliver message module 902 can be implemented with the navigation system 800 of FIG. 8 using the first device 802 of FIG. 8 and the second device 806 of FIG. 8. The deliver message module 902 can be implemented with the first user interface 818 of FIG. 8, the first display interface 830 of FIG. 8, the first control unit 812 of FIG. 8, the first storage unit 814 of FIG. 8, the first location unit 820 of FIG. 8, the first communication unit 816 of FIG. 8, or a combination thereof.

The deliver message module 902 can be further implemented with the second control unit 834 of FIG. 8, the second user interface 838 of FIG. 8, the second display interface 840 of FIG. 8, the second storage unit 846 of FIG. 8, the second communication unit 836 of FIG. 8, or a combination thereof.

For example, the navigation system 900 can deliver the first message 226 and display it on the first user interface 818. The second control unit 834 can retrieve the first message 226 from the second storage unit 846. The second storage unit 846 can have a larger capacity and better retrieval performance than the first storage unit 814. The second storage unit 846 can send the first message 226 to the first communication unit 816 via the communication path 804 using the second communication unit 836. The first control unit 812 can receive the first message 226 from the first communication unit 816 and display it on the first user interface 818. The first message 226 can be stored in the first storage unit 814.

The calculate detection geofence module 904 can be implemented with the navigation system 800. The calculate detection geofence module 904 can be implemented with the first control unit 812, the first storage unit 814, the first location unit 820, the second control unit 834, the second storage unit 846, or a combination thereof.

For example, the navigation system 900 can calculate the business detection geofence 222 using the second control unit 834 and the target location 924. The second control unit 834 can retrieve the target location 924 of the first message 226 from the second storage unit 846. The second control unit 834 can calculate the business detection geofence 222 based on the target location 924.

The navigation module 906 can be implemented with the navigation system 800. The navigation module 906 can be implemented with the first control unit 812, the first location unit 820, the first display interface 830, the first user interface 818, first communication unit 816, the second control unit 834, the second communication unit 836, or a combination thereof.

For example, the navigation system 900 can navigate the user to the target location 924 by displaying the navigation routing information 940 on the first display interface 830. The first location unit 820 can determine the current location 210 to be used to update the first display interface 830. The second control unit 834 can send the navigation routing information 940 from the second storage unit 846 to the second communication unit 836. The second communication unit 836 can send the navigation routing information 940 to the first communication unit 816 via the communication path 804. The first control unit 812 can retrieve the navigation routing information 940 from the first communication unit 816 and send it to the first user interface 818.

The detect encounter module 908 can be implemented with the navigation system 800. The detect encounter module 908 can be implemented with first control unit 812, the first storage unit 814, the first location unit 820, the first communication unit 816, the first display interface 830, the first user interface 818, or a combination thereof. The detect encounter module 908 can be further implemented with the second control unit 834, the second storage unit 846, the second communication unit 836, the second user interface 838, the second display interface 840, or a combination thereof.

For example, the navigation system 900 can detect the encounter 930 using the first control unit 812 and the first location unit 820 to determine if the current location 210 is at or within the business detection geofence 222. The first control unit 812 can send the current location 210 to the second communication unit 836 via the communication path 804 using the first communication unit 816. The second control unit 834 can detect the encounter 930 by comparing the current location 210 to the business detection geofence 222.

The validate encounter type module 910 can be implemented with the navigation system 800. The validate encounter type module 910 can be implemented with first control unit 812, the first storage unit 814, the first communication unit 816, the first display interface 830, the first user interface 818, or a combination thereof.

The validate encounter type module 910 can be further implemented with the second control unit 834, the second storage unit 846, the second communication unit 836, or a combination thereof.

For example, the navigation system 900 can validate the encounter type 960 of the encounter 930 using the second control unit 834 and the user history 962. The first control unit 812 can detect the encounter 930 using the first location unit 820 and the business detection geofence 222. The first control unit 812 can send the encounter 930 to the second communication unit 836 via the communication path 804 using the first communication unit 816. The second control unit 834 can retrieve the encounter 930 from the second communication unit 836 and retrieve the user history 962 from the second storage unit 846. The second control unit 834 can validate the encounter type 960 by comparing the encounter 930 to the user history 962.

It has also been discovered that the present invention provides the navigation system 900 with geofence validation of encounter type mechanism for improving performance, increasing reliability, and reducing cost. The navigation system 900 can validate the encounter type 960 of the encounter 930 using the current location 210, the business detection geofence 222, and the user history 962, thus allowing different behavior for each type of encounter. In addition, using the business detection geofence 222 to detect the encounter 930 with the first business 220 can increase the reliability by requiring that the user actually physically visit the target location 924.

The physical transformation of the current location 210 of the navigation system 900 to be at or within the business detection geofence 222 can result in movement in the physical world. This can include people or vehicles using the first device 102 of FIG. 1 of the navigation system 900 to navigate to the target location 924. As the movement in the physical world occurs, the movement itself creates additional information that is converted back to assist in the detection of the encounter 930 and the validation of the encounter type 960. This can include updates to the user history 962 as the navigation system 100 navigates to the target location 924 and detects the encounter 930. The continued operation of the navigation system 100 with geofence validation of encounter type mechanism allows the navigation in the physical world to the target location 924 as the current location 210 changes.

The navigation system 900 describes the module functions or order as an example. The modules can be partitioned differently. For example, the detect encounter module 908 can be performed by executing the software 712 of FIG. 7 with the control unit 708 of FIG. 7 in a single device configuration or by executing the first software 826 of FIG. 8 with the first control unit 812 of FIG. 8 and executing the second software 842 of FIG. 8 on the second control unit 834 of FIG. 8 in a two device configuration. Each of the modules can operate individually and independently of the other modules.

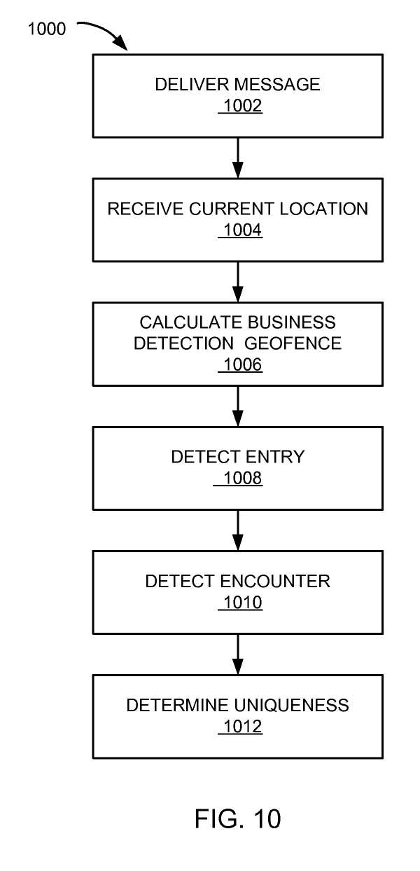

Referring now to FIG. 10, therein is shown a flow chart of a method 1000 of operation of the navigation system 100 in a further embodiment of the present invention. The method 1000 includes: delivering a first message with a target location for a first business for displaying on a device in a block 1002; receiving a current location for locating the device in a block 1004; calculating a business detection geofence encompassing the target location for detecting the location of the device in the target area of the business detection geofence in a block 1006; detecting an entry into the business detection geofence for detecting the current location of the device being at or within the business detection geofence in a block 1008; detecting an encounter between the device and the business detection geofence for the entry into the business detection geofence in a response to the first message in a block 1010; and determining a uniqueness of the encounter for indicating the encounter between the device and the business detection geofence in a block 1012.

The resulting method and system is straightforward, cost-effective, uncomplicated, highly versatile, sensitive, and accurate. The method can be implemented by adapting known components for ready, efficient, and economical manufacturing, application and utilization.

Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations can be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a navigation system comprising:
delivering a first message with a target location for a first business for displaying on a device;
receiving a current location for locating the device;
calculating a business detection geofence encompassing the target location for detecting the location of the device in the target area of the business detection geofence;
detecting an entry into the business detection geofence for detecting the current location of the device being at or within the business detection geofence;
detecting an encounter between the device and the business detection geofence for the entry into the business detection geofence in a response to the first message; and
determining a uniqueness of the encounter for indicating the encounter between the device and the business detection geofence.

2. The method as claimed in claim 1 further comprising:
calculating a user search geofence encompassing the device; and
wherein delivering the first message includes:
delivering the first message with the target location at or within the user search geofence.

3. The method as claimed in claim 1 further comprising:
calculating a business message geofence encompassing the target location; and
wherein delivering the first message includes:
delivering the first message based on the current location being at or within the business message geofence.

4. The method as claimed in claim 1 further comprising varying a size of the user search geofence, for encompassing the device, based on the type of search being performed to compensate for a likelihood of finding the search term target within the user search geofence.

5. The method as claimed in claim 1 wherein detecting the encounter includes detecting a user action based on the current location being at or within the business detection geofence to show interaction with the first business.

6. A method of operation of a navigation system comprising:
calculating a business message geofence around a first business;
delivering a first message with a target location for a first business for displaying on a device;
receiving a current location for locating the device;
calculating a business detection geofence encompassing the target location for detecting the location of the device in the target area of the business detection geofence;
detecting an entry into the business detection geofence for detecting the current location of the device being at or within the business detection geofence;
detecting an encounter between the device and the business detection geofence for the entry into the business detection geofence in a response to the first message; and
determining a uniqueness of the encounter for indicating the encounter between the device and the business detection geofence.

7. The method as claimed in claim 6 further comprising:
determining the shape of a user search geofence based on the current speed and current location to compensate for the area that can be reached within a predetermined time;
determining the size of the user search geofence based on the current speed and current location to compensate for the area that can be reached within a predetermined time; and
calculating a user search geofence, for encompassing the device, based on the shape and size of the area that can be reached within a predetermined time.

8. The method as claimed in claim 6 further comprising:
calculating a user detection geofence based on the current location; and
wherein detecting the encounter includes:
detecting the user detection geofence intersecting the business detection geofence.

9. The method as claimed in claim 6 further comprising modifying the first message based on the distance between the current location and the target location of the first business for increasing a desirability of the first message by increasing the utility of the first message where the distance is greater than a predetermined distance.

10. The method as claimed in claim 6 wherein detecting the encounter with the first business as the response to the first message based on detecting the current location as stationary in the business detection geofence.

11. A navigation system comprising:
a control unit for delivering a first message with a target location for a first business for displaying on a device;
a location unit, coupled to the control unit, for receiving a current location for monitoring the device;
a calculate detection geofence module, coupled to the location unit, for calculating a business detection geofence encompassing the target location of the first business for detecting the device;
a navigation module, coupled to the location unit, for detecting an entry to the business detection geofence for detecting the current location at or within the business detection geofence;
a detect encounter module, coupled to the control unit, for detecting an encounter in a response to the first message; and
a validate encounter type module, coupled to the control unit, for determining a uniqueness of the encounter.

12. The system as claimed in claim 11 further comprising:
a deliver message module, coupled to the control unit for calculating a user search geofence encompassing the device; and
wherein delivering the first message includes:
a communication unit, coupled to the location unit, for delivering the first message with the target location at or within the user search geofence.

13. The system as claimed in claim 11 further comprising:
the deliver message module, coupled to the control unit, for calculating a business message geofence encompassing the target location; and
wherein delivering the first message includes:
a communication unit, coupled to the deliver message module, for delivering the first message based on the current location being at or within the business message geofence.

14. The system as claimed in claim 11 further comprising a controller interface, coupled to the control unit for varying a size of the user search geofence, for encompassing the device, based on the search being performed to compensate for a likelihood of finding the search term target within the user search geofence.

15. The system as claimed in claim 11 further comprising a detect encounter module, coupled to the location unit, for detecting a user action based on the current location being at or within the business detection geofence to show interaction with the first business.

16. A navigation system comprising:
a control unit for delivering a first message with a target location for a first business with the current location at or within the business message geofence for displaying on the device;
a location unit, coupled to the control unit, for receiving a current location for monitoring a device;
a storage unit, coupled to the control unit, for calculating a business message geofence around a first business;
a calculate detection geofence module, coupled to the location unit, for calculating a business detection geofence around the target location of the first business;
a navigation module, coupled to the location unit, for detecting an entry into the business detection geofence for detecting the current location at or within the business detection geofence;
a detect encounter module, coupled to the control unit, for detecting an encounter in a response to the first message; and
a validate encounter type module, coupled to the control unit, for determining a uniqueness of the encounter.

17. The system as claimed in claim 16 further comprising:
a deliver message module, coupled to the location interface, for determining the shape of a user search geofence based on the current speed and current location to compensate for the area that can be reached within a predetermined time;
the deliver message module, coupled to the location unit, for determining the size of the user search geofence based on the current speed and current location to compensate for the area that can be reached within a predetermined time; and
a deliver message module, coupled to the control unit, for calculating a user search geofence, for encompassing the device, based on the shape and size of the area that can be reached within a predetermined time.

18. The system as claimed in claim 16 further comprising:
a calculate detection geofence module, coupled to the location unit, for calculating a user detection geofence based on the current location; and
wherein detecting the encounter includes:
the detect encounter module, coupled to the control unit, for detecting the user detection geofence intersecting the business detection geofence.

19. The system as claimed in claim 16 further comprising a deliver message module coupled to the location unit, for modifying the first message based on the distance between the current location and the target location of the first business for increasing a desirability of the first message by increasing the utility of the first message where the distance is greater than a predetermined distance.

20. The system as claimed in claim 16 wherein a detect encounter module, coupled to the location unit, for detecting the encounter with the first business as the response to the first message based on detecting the current location as stationary in the business detection geofence.
